(19) United States
(12) Patent Application Publication
(10) Pub. No.: US 2026/0067149 A1
(43) Pub. Date: Mar. 5, 2026

(54) COMPACT REPRESENTATION OF FDSS FILTERS

(71) Applicant: Samsung Electronics Co., Ltd., Suwon-si (KR)

(72) Inventors: Nuwan S. Ferdinand, Stittsville (CA); Joonyoung Cho, Portland, OR (US)

(21) Appl. No.: 19/043,371

(22) Filed: Jan. 31, 2025

Related U.S. Application Data
(60) Provisional application No. 63/691,059, filed on Sep. 5, 2024.
(60) Provisional application No. 63/692,371, filed on Sep. 9, 2024.

(51) Int. Cl. H04L 27/26; H04L 5/00; H04L 25/03; H04W 72/1273

(52) U.S. Cl. CPC H04L 27/2636; H04L 5/0044; H04L 25/03834; H04W 72/1273

(57) ABSTRACT

A method of operating an electronic device includes phase rotating an input data vector u of length Ma according to predetermined phase rotation parameters, to generate a phase-rotated data vector, and performing a DFT on the phase-rotated data vector to generate DFT-transformed data. The method also includes applying spectral extension to the transformed data by cyclically extending the DFT-transformed data to produce an extended data vector, performing FDSS by element-wise multiplication of the extended data vector with FDSS coefficients to generate FDSS-processed data, and mapping the FDSS-processed data onto a plurality of subcarriers to generate subcarrier-mapped data. The method also includes performing an IDFT on the subcarrier-mapped data to generate IDFT-transformed data, adding a cyclic prefix to the IDFT-transformed data to generate an output signal, and transmitting the output signal.

### CROSS-REFERENCE TO RELATED APPLICATIONS AND CLAIM OF PRIORITY

This application claims priority under 35 U.S.C. § 119 (e) to U.S. Provisional Patent Application No. 63/691,059 filed on Sep. 5, 2024, and U.S. Provisional Patent Application No. 63/692,371 filed on Sep. 9, 2024. The above-identified provisional patent application is hereby incorporated by reference in its entirety.

### TECHNICAL FIELD

This disclosure relates generally to wireless networks. More specifically, this disclosure relates to compact representation of frequency domain spectral shaping (FDSS) filters.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for compact representation of FDSS filters.

In one embodiment, and electronic device is provided. The electronic device includes a processor. The processor is configured to phase rotate an input data vector u of length Ma according to predetermined phase rotation parameters, to generate a phase-rotated data vector, and perform a discrete Fourier transform (DFT) on the phase-rotated data vector to generate DFT-transformed data. The processor is also configured to apply spectral extension to the transformed data by cyclically extending the DFT-transformed data to produce an extended data vector, perform frequency domain spectral shaping (FDSS) by element-wise multiplication of the extended data vector with FDSS coefficients to generate FDSS-processed data, and map the FDSS-processed data onto a plurality of subcarriers to generate subcarrier-mapped data. The processor is also configured to perform an inverse discrete Fourier transform (IDFT) on the subcarrier-mapped data to generate IDFT-transformed data, and add a cyclic prefix to the IDFT-transformed data to generate an output signal. The electronic device also includes a transceiver operatively coupled to the processor. The transceiver is configured to transmit the output signal.

In another embodiment, a method of operating an electronic device is provided. The method includes phase rotating an input data vector u of length Ma according to predetermined phase rotation parameters, to generate a phase-rotated data vector, and performing a DFT on the phase-rotated data vector to generate DFT-transformed data. The method also includes applying spectral extension to the transformed data by cyclically extending the DFT-transformed data to produce an extended data vector, performing FDSS by element-wise multiplication of the extended data vector with FDSS coefficients to generate FDSS-processed data, and mapping the FDSS-processed data onto a plurality of subcarriers to generate subcarrier-mapped data. The method also includes performing an IDFT on the subcarrier-mapped data to generate IDFT-transformed data, adding a cyclic prefix to the IDFT-transformed data to generate an output signal, and transmitting the output signal.

In yet another embodiment, a non-transitory computer readable medium embodying a computer program is provided. The computer program includes program code that, when executed by a processor of a device, causes the device to phase rotate an input data vector u of length Ma according to predetermined phase rotation parameters, to generate a phase-rotated data vector, and perform a DFT on the phase-rotated data vector to generate DFT-transformed data. The program code also causes the device to apply spectral extension to the transformed data by cyclically extending the DFT-transformed data to produce an extended data vector, perform FDSS by element-wise multiplication of the extended data vector with FDSS coefficients to generate FDSS-processed data, and map the FDSS-processed data onto a plurality of subcarriers to generate subcarrier-mapped data. The program code also causes the device to perform an inverse IDFT on the subcarrier-mapped data to generate IDFT-transformed data, add a cyclic prefix to the IDFT-transformed data to generate an output signal, and transmit the output signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example transmitter according to embodiments of the present disclosure;

FIG. 5 illustrates an example procedure for operation of a transmitter according to embodiments of the present disclosure;

FIG. 6 illustrates an example of values of P_{R}_{ₛₑ}₍ᵣ₎ according to embodiments of the present disclosure;

FIG. 7 illustrates another example of values of P_{R}_{ₛₑ}₍ᵣ₎ according to embodiments of the present disclosure;

FIG. 8 illustrates another example of values of P_{R}_{ₛₑ}₍ᵣ₎ according to embodiments of the present disclosure;

FIG. 9 illustrates another example of values of P_{R}_{ₛₑ}₍ᵣ₎ according to embodiments of the present disclosure;

FIG. 10 illustrates another example of values of P_{R}_{ₛₑ}₍ᵣ₎ according to embodiments of the present disclosure;

FIG. 11 illustrates another example of values of P_{R}_{ₛₑ}₍ᵣ₎ according to embodiments of the present disclosure;

FIG. 12 an example procedure for uplink signaling according to embodiments of the present disclosure; and

FIG. 13 illustrates an example method for compact representation of FDSS filters according to embodiments of the present disclosure.

### DETAILED DESCRIPTION

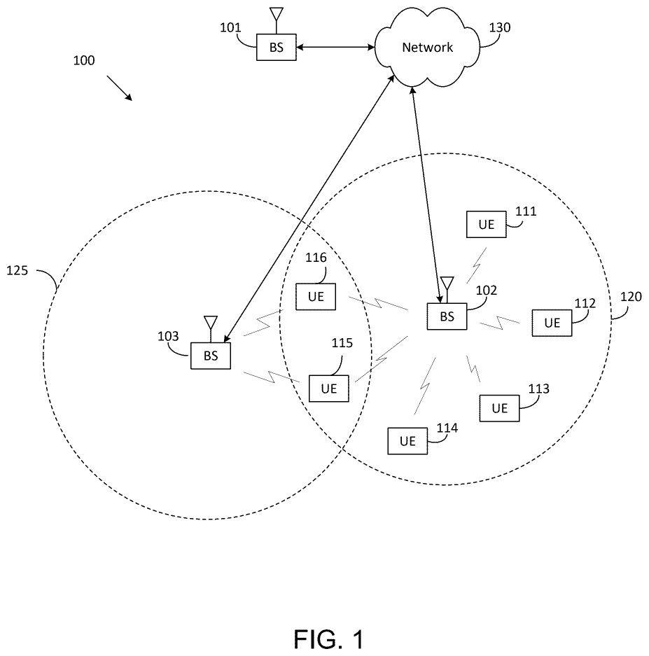

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for compact representation of FDSS filters. In certain embodiments, one or more of the gNBs 101-103 includes circuitry, programing, or a combination thereof, to support compact representation of FDSS filters in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

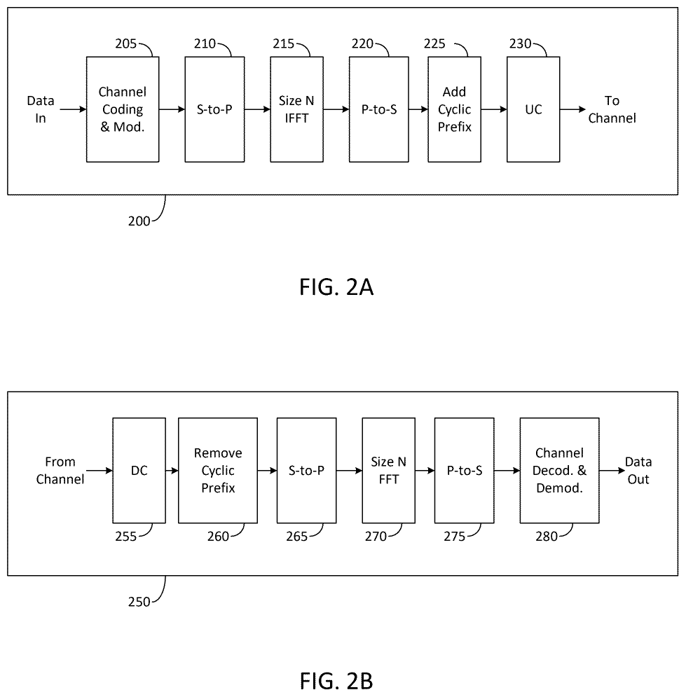

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support compact representation of FDSS filters as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

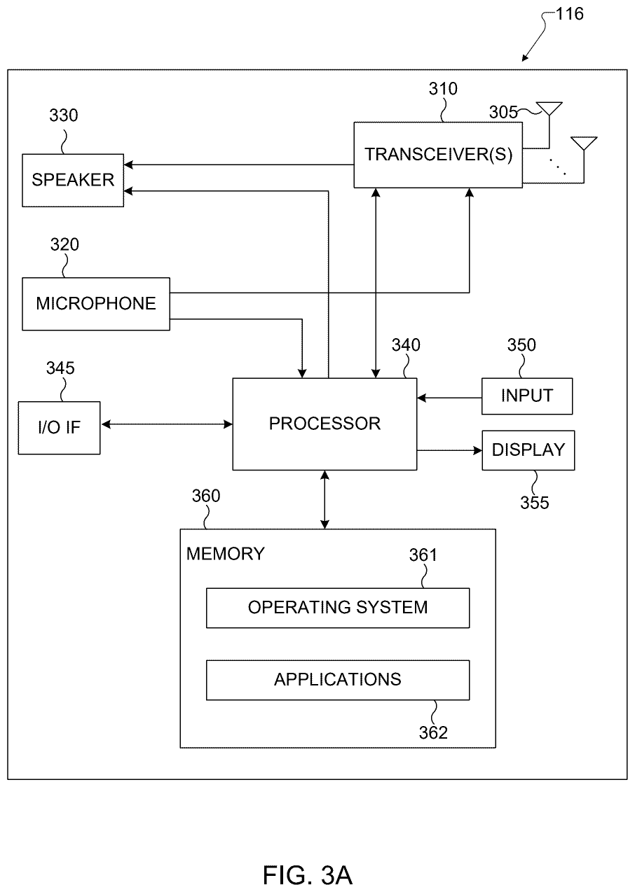

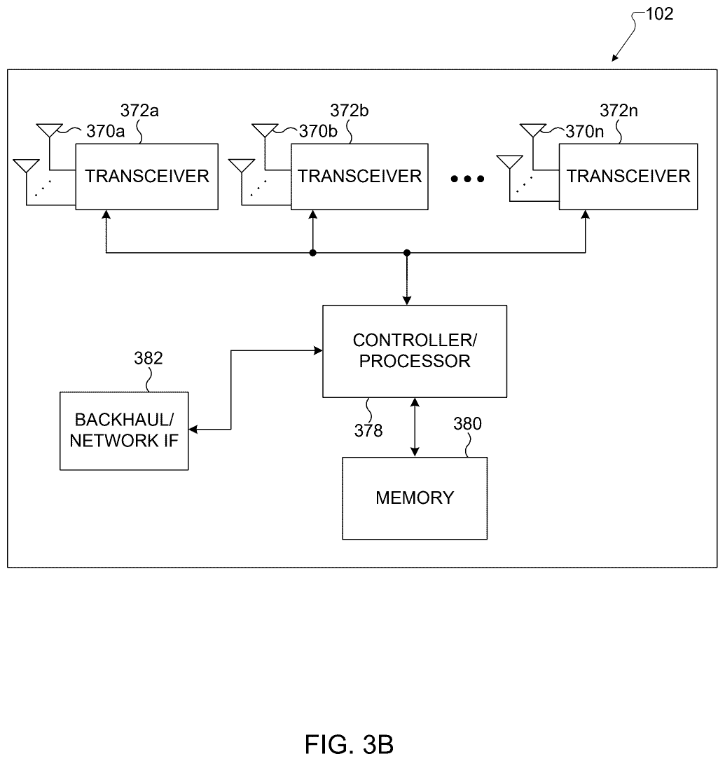

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for compact representation of FDSS filters as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support compact representation of FDSS filters as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

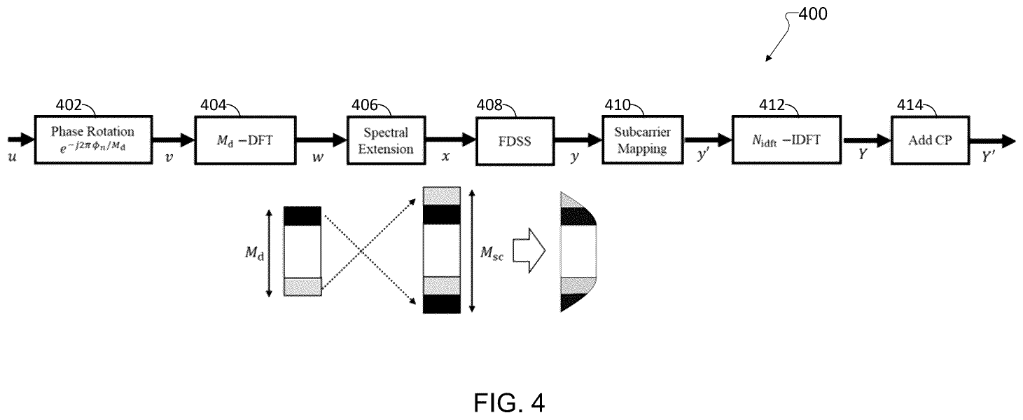

Frequency Domain Spectral Shaping (FDSS) can be used to design low Peak to Average Power Ratio (PAPR) waveforms. FDSS changes the underlying pulse shape that is carrying the modulation symbols. The pulses have sidelobes and these sidelobes add together creating peaks, thus increasing the PAPR. A well-designed pulse shape is able to minimize the overlapping sidelobes and is able to reduce PAPR. However, a simple design of pulse shapes to reduce the PAPR often results in Inter Symbol Interference (ISI), thus impacting link level performance. Various embodiments of the present disclosure provide for pulse shapes that can achieve multiple PAPR vs ISI tradeoffs. In some embodiments, such as the transmitter of FIG. 4, the pulse shapes are formed using a low dimensional Fourier basis using the symmetrical property of the pulses, thus they can be represented in compact forms.

FIG. 4 illustrates an example transmitter 400 according to embodiments of the present disclosure. The embodiment of a transmitter of FIG. 4 is for illustration only. Different embodiments of a transmitter could be used without departing from the scope of this disclosure.

In the example of FIG. 4, it should be understood that in some embodiments, transmitter 400 may be combined with or replace one or more components of transmit path 200 of FIG. 2A in a UE or a gNB. In some embodiments, one or more components of transmitter 400 may be implemented in a processor.

Transmitter 400 includes a phase rotation block 402, a discrete Fourier transform (DFT) block 404, a spectral extension (SE) block 406, an FDSS block 408, a subcarrier mapping block 410, an inverse discrete Fourier transform (IDFT) block 412, and an add cyclic prefix (CP) block 414.

In transmitter 400, the phase rotation block receives as input an Ma length data vector u=[u(0) u(1) . . . u(M_{d}−1)]. The elements u (m) are selected from a modulation constellation set. This modulation constellation set may contain any real, imaginary, or complex values. Examples for these modulation constellation sets are binary phase shift keying (BPSK), π/2-BPSK, QPSK, or any order of QAM. Any other modulation set is also possible such as an artificial intelligence (AI)/machine learning (ML) optimized constellation set.

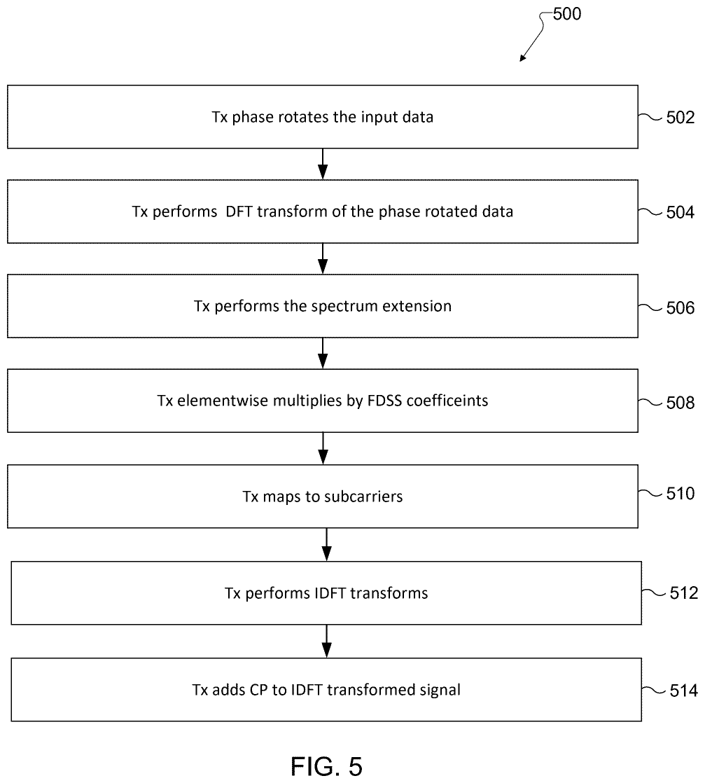

The phase rotation block 402 phase rotates the input data vector u=[u(0), u(1), . . . , u(M_{d}−1)] to generate a phase-rotated data vector v=[v(0), v(1), . . . , v(M_{d}−1)], similarly as described regarding operation 502 of FIG. 5.

The DFT block 404 transforms the phase-rotated data vector v=[v(0), v(1), . . . , v(M_{d}−1)] using DFT to generate DFT-transformed data w=[w(0), w(1), . . . , w(M_{d}−1)], similarly as described regarding operation 504 of FIG. 5.

The SE block 406, cyclically extends the DFT-transformed data w=[w(0), w(1), . . . , w(M_{d}−1)] to generate an extended data vector x=[x(0), x(1), . . . , x(M_{sc}−1)], similarly as described regarding operation 506 of FIG. 5. In some embodiments, an additional cyclic shift of x by ±M_{sc} is performed such that a new extended data vector x(m)=x([m±M_{sc}]_{M}_{_{sc}}), where and [·]_{M}_{_{sc}} denotes the modulo operation by M_{sc}, similarly as described regarding operation 506 of FIG. 5.

The FDSS block 408 elementwise multiplies the extended data vector x=[x(0), x(1), . . . , x(M_{sc}−1)] by FDSS coefficients f_{R}_{ₛₑ}_{(r),t}=[f_{R}_{ₛₑ}_{(r),t}(0), f_{R}_{ₛₑ}_{(r),t}(1), . . . , f_{R}_{ₛₑ}_{(r),t}(M_{sc}−1)] according to y(m)=f_{R}_{ₛₑ}_{(r),t}(m)x(m) to generate FDSS-processed data y=[y(0), y(1), . . . , y(M_{sc}−1)], similarly as described regarding operation 508 of FIG. 5.

The subcarrier mapping block 410 maps the FDSS-processed data y=[y(0), y(1), . . . , y(M_{sc}−1)] to M_{sc} subcarriers out of total of N_{idft} subcarriers to generate subcarrier-mapped data y′=[y′(0), y′(1), . . . , y′(N_{idft}−1)], similarly as described regarding operation 510 of FIG. 5.

The inverse discrete Fourier transform (IDFT) block 412 transforms the subcarrier-mapped data y′=[y′(0), y′(1), . . . , y′(N_{idft}−1)] using IDFT to generate IDFT-transformed data Y=[Y(0), Y(1), . . . , Y(N_{idft}−1)], similarly as described regarding operation 512 of FIG. 5.

The CP block 414 adds CPs to the DFT-transformed data Y=[Y(0), Y(1), . . . , Y(N_{idft}−1)] to generate an output signal Y′(n)=Y([N_{idft}−S+n]_{N}_{_{idft}}), where S is the length of the CP, similarly as described regarding operation 512 of FIG. 5.

Although FIG. 4 illustrates an example transmitter 400, various changes may be made to FIG. 4. For example, while illustrated with discrete components, the various components of transmitter 400 could be combined into a single component, etc. according to particular needs. Furthermore, while described as being implemented in a transmitter, the operations of the various components of FIG. 4 may be performed by another device, such as a processor. For example, one or more of the operations performed by the components of FIG. 4 could be performed by processor 340 of FIG. 3A, or processor 378 of FIG. 3B.

FIG. 5 illustrates an example procedure 500 for operation of a transmitter according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for operation of a transmitter could be used without departing from the scope of this disclosure.

In the example of FIG. 5, procedure 500 begins at operation 502. At operation 502, a transmitter (such as transmitter 400 of FIG. 4) phase rotates (e.g., by block 402 of transmitter 400) an input data vector u=[u(0), u(1), . . . , u(M_{d}−1)] according to

$$v ( m ) = u ( m ) {e}^{- \frac{j 2 π {ϕ}_{m}}{{M}_{d}}}$$

to generate v=[v(0), v(1), . . . , v(M_{d}−1)]. The φₘ is specified using K parameters a=[a(0), a(1), . . . , a(K−1)] such that φₘ is given by

$${ϕ}_{m} = {\sum }_{k = 0}^{K - 1} a ( k ) {m}^{k} .$$

In some embodiments, the parameters a=[a(0), a(1), . . . , a(K−1)] are obtained to satisfy the following conditions:

$${\sum }_{k = 0}^{K - 1} a ( k ) {m}^{k} = \{ \begin{matrix}\frac{λ {M}_{d}}{4} , & m ∈ {χ}_{1} \\ ( \frac{λ}{4} + \frac{γ}{8} ) {M}_{d} , & m ∈ {χ}_{2}\end{matrix}$$

where λ is any integer and γ is any nonzero integer. The χ₁ is a set of even integers and χ₂ is a set of odd integers. In alternatively, in some embodiments, χ₁ is a set of odd integers and χ₂ is a set of even integers.

In some embodiments, these conditions are achieved by setting a(1)=βM_{d}/8 where β is any non-zero integer, a(k)=0 for k≥2, and a(0) is any real number. Such that

$${ϕ}_{m} = a ( 0 ) + \frac{β {M}_{d} m}{8}$$

Alternatively, in some embodiments, these conditions may be achieved by setting a(k)=βM_{d}/8 for only one k≥2 where β non-zero integers and is any real number. Such that for k≥2

$${ϕ}_{m} = a ( 0 ) + \frac{β {M}_{d} {m}^{k}}{8}$$

At operation 504, the transmitter transforms (e.g., by block 404 of transmitter 400) the phase rotated data v=[v(0), v(1), . . . , v(M_{d}−1)] using DFT as

$$w ( m ) = \frac{1}{\sqrt{{M}_{d}}} {\sum }_{n = 0}^{{M}_{d} - 1} v ( n ) {e}^{- \frac{j 2 π n m}{{M}_{d}}}$$

to obtain w=[w(0), w(1), . . . , w(M_{d}−1)].

At operation 506, the transmitter performs SE (e.g., by block 404 of transmitter 400) on the output w=[w(0), w(1), . . . , w(M_{d}−1)] as follows:

The transmitter is allocated with M_{sc} subcarriers. The communication network may support one or many SE ratios Rₛₑ, The R SE ratios are specified as Rₛₑ(0), Rₛₑ(1), . . . , Rₛₑ(R−1) where R≥1. Rₛₑ(r) is a function of M_{sc}, M_{d}, and Mₛₑ where Mₛₑ=M_{sc}−M_{d} is the SE length. In some embodiments Rₛₑ(r)=Mₛₑ/M_{d}. In some embodiments Rₛₑ(r)=Mₛₑ/M_{sc}. Alternatively, in some embodiments, the form for Rₛₑ(r) may be derived. However, once Rₛₑ(r) and at least one of the M_{sc}, M_{d}, Mₛₑ are given, M_{sc}, M_{d}, Mₛₑ can be found. For Rₛₑ(r)=Mₛₑ/M_{d}, Rₛₑ(r) ranges from 0 to 1, where 0 refers to Mₛₑ=0 and 1 refers to Mₛₑ=Ma. Therefore, the SE length Mₛₑ can range from 0 to M_{d}. W=[w(0), w(1), . . . , w(M_{d}−1)] is cyclically extended to find x=[x(0), x(1), . . . , x(M_{sc}−1)] such that

$$x ( m ) = \{ \begin{matrix}w ( {M}_{d} - \frac{{M}_{se}}{2} + m ) , 0 \leq m \leq \frac{{M}_{se}}{2} - 1 \\ w ( m - \frac{{M}_{se}}{2} ) , \frac{{M}_{se}}{2} \leq m \leq {M}_{d} + \frac{{M}_{se}}{2} - 1 \\ w ( m - {M}_{d} + \frac{{M}_{se}}{2} ) , {M}_{d} + \frac{{M}_{se}}{2} \leq m \leq {M}_{sc} - 1\end{matrix}$$

In some embodiments, an additional cyclic shift of x by ±M_{sc} may be performed such that the new x(m)=x([m±M_{sc}]_{M}_{_{sc}}) where [·]_{M}_{_{sc}} denotes the modulo operation by M_{sc}.

At operation 508, the transmitter elementwise multiplies (e.g., by block 408 of transmitter 400) the output x=[x(0), x(1), . . . , x(M_{sc}−1)] by FDSS coefficients f_{R}_{ₛₑ}_{(r),t}=[f_{R}_{ₛₑ}_{(r),t} (0), f_{R}_{ₛₑ}_{(r),t} (1), . . . , f_{R}_{ₛₑ}_{(r),t} (M_{sc}−1)] according to y(m)=f_{R}_{ₛₑ}_{(r),t} (m)x(m) to obtain y=[y(0), y(1), . . . , y(M_{sc}−1)].

In some embodiments, for each Rₛₑ(r), T distinct FDSS filters p_{R}_{_{se(r),0}}, p_{R}_{ₛₑ}_{(r),1}, . . . p_{R}_{ₛₑ}_{(r),T-1} are specified where the FDSS filter p_{R}_{ₛₑ}_{(r),t} are specified using L_{R}_{ₛₑ}_{(r),t} parameters p_{R}_{ₛₑ}_{(r),t}=[p_{R}_{ₛₑ}_{(r),t} (0), p_{R}_{ₛₑ}_{(r),t}(1), . . . , p_{R}_{ₛₑ}_{(r),t} (L_{R}_{ₛₑ}_{(r),t}−1)].

Based on the p_{R}_{ₛₑ}_{(r),t}, the FDSS coefficient f_{R}_{ₛₑ}_{(r),t}=[f_{R}_{ₛₑ}_{(r),t} (0), f_{R}_{ₛₑ}_{(r),t} (1), . . . , f_{R}_{ₛₑ}_{(r),t} (M_{sc}−1)] is given by

$${f}_{{R}_{s e} ( r ) , t} ( m ) = \sqrt{{p}_{{R}_{s e} ( r ) , t} ( 0 ) + {\sum }_{l = 1}^{{L}_{{R}_{s e} ( r ) , t - 1}} {p}_{{R}_{s e} ( r ) , t} ( l ) ( {e}^{- \frac{j π \tilde{m} ( 2 l - 1 )}{{M}_{d}}} + {e}^{- \frac{j π \tilde{m} ( 2 {M}_{d} - 2 l + 1 )}{{M}_{d}}} )}$$

### Where

$$\tilde{m} = {[ - \frac{{M}_{s e}}{2} + m ]}_{2 {M}_{d}}$$

and [·]_{2M}_{_{d}} denotes the modulo operation by 2M_{d}.

Table 1 lists the FDSS filters for a few SE ratios for L_{R}_{ₛₑ}₍ᵣ₎=3. Table 2 lists the FDSS filters for a few SE ratios for L_{R}_{ₛₑ}₍ᵣ₎=2.

TABLE 1
FDSS filters with L_{R}_{ₛₑ}₍ᵣ₎ = 3

| SE ratio | SE ratio (Rₛₑ(r) = | |
|---|---|---|
| (Rₛₑ(r) = Mₛₑ/M_{d}) | Mₛₑ/M_{sc}) | _{pR}_{ₛₑ}₍ᵣ₎ |
| 1/20 | 1/21 | [1, 0.437, 0.017] |
| 1/10 | 1/11 | [1, 0.527, 0.010] |
| ⅛ | 1/9 | [1, 0.572, −0.002] |
| 3/20 | 3/23 | [1, 0.618, 0.001] |
| ⅕ | ⅙ | [1, 0.672, −0.020] |
| ¼ | ⅕ | [1, 0.712, −0.041] |
| 3/10 | 3/13 | [1, 0.753, −0.049] |
| ⅓ | ¼ | [1, 0.763, −0.049] |

TABLE 2
FDSS filters with L_{R}_{ₛₑ}₍ᵣ₎ = 2

| SE ratio (Rₛₑ(r) = | SE ratio (Rₛₑ(r) = | |
|---|---|---|
| Mₛₑ/M_{d}) | Mₛₑ/M_{sc}) | p_{R}_{ₛₑ}₍ᵣ₎ |
| 1/20 | 1/21 | [1, 0.457] |
| 1/10 | 1/11 | [1, 0.545] |
| ⅛ | 1/9 | [1, 0.577] |
| 3/20 | 3/23 | [1, 0.627] |
| ⅕ | ⅙ | [1, 0.710] |
| ¼ | ⅕ | [1, 0.777] |
| 3/10 | 3/13 | [1, 0.832] |
| ⅓ | ¼ | [1, 0.848] |

Alternatively, in some embodiments, for L_{R}_{ₛₑ}₍ᵣ₎=2, the FDSS filters for

$${R}_{s e} ( r ) = \frac{{M}_{s e}}{{M}_{d}} = {z}_{d}$$

are given by

$${p}_{{R}_{s e} ( r )} = [ 1 , 0.387 + 1.244 {z}_{d} + 3.859 {z}_{d}^{2} - 10.278 {z}_{d}^{3} ] \qquad ( 1 )$$

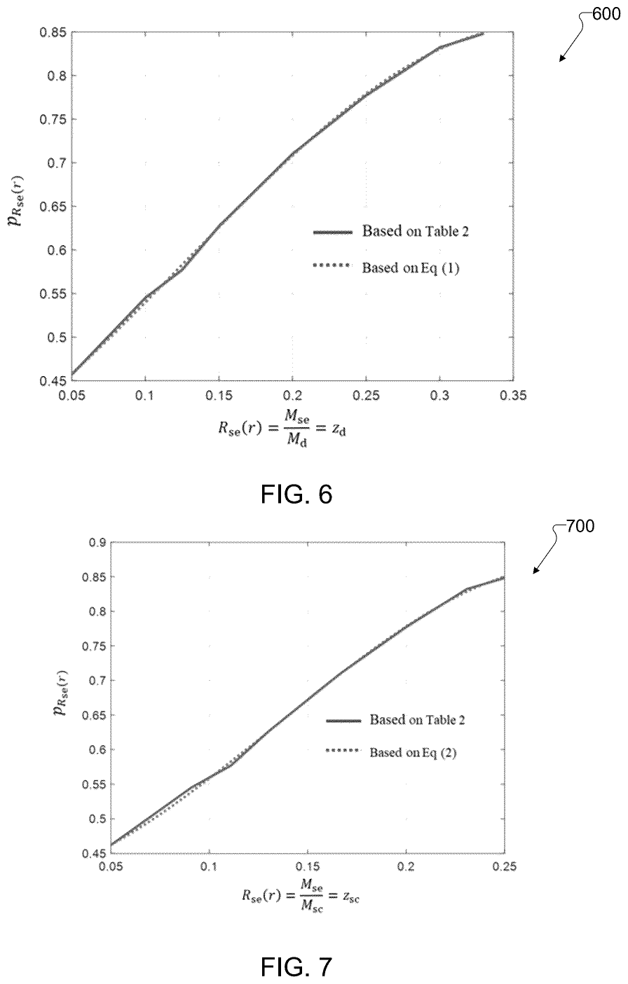

FIG. 6 illustrates an example 600 of values of P_{R}_{ₛₑ}₍ᵣ₎ according to embodiments of the present disclosure. The embodiment of values of P_{R}_{ₛₑ}₍ᵣ₎ of FIG. 6 is for illustration only. Different embodiments of values of P_{R}_{ₛₑ}₍ᵣ₎ could be used without departing from the scope of this disclosure.

In the example of FIG. 6, the values of P_{R}_{ₛₑ}₍ᵣ₎ are based on Table 2 and above equation (1) for

$${R}_{s e} ( r ) = \frac{{M}_{s e}}{{M}_{d}} = {z}_{d} .$$

Alternatively, in some embodiments, for L_{R}_{ₛₑ}₍ᵣ₎=2, the FDSS filters for

$${R}_{s e} ( r ) = \frac{{M}_{s e}}{{M}_{s c}} = {z}_{s c}$$

are given by

$${p}_{{R}_{s e} ( r )} = [ 1 , 0.41 + 0.427 {z}_{s c} + 14.016 {z}_{s c}^{2} - 34.722 {z}_{s c}^{3} ] \qquad ( 2 )$$

FIG. 7 illustrates another example 700 of values of P_{R}_{ₛₑ}₍ᵣ₎ according to embodiments of the present disclosure. The embodiment of values of P_{R}_{ₛₑ}₍ᵣ₎ of FIG. 7 is for illustration only. Different embodiments of values of P_{R}_{ₛₑ}₍ᵣ₎ could be used without departing from the scope of this disclosure.

In the example of FIG. 7, the values of P_{R}_{ₛₑ}₍ᵣ₎ are based on Table 2 and above equation (2) for

$${R}_{s e} ( r ) = \frac{{M}_{s e}}{{M}_{s c}} = {z}_{s c} .$$

At operation 510, the transmitter maps (e.g., by block 410 of transmitter 400) the output y=[y(0), y(1), . . . , y(M_{sc}−1)] to M_{sc} subcarriers out of total of N_{idft} subcarriers y′=[y′(0), y′(1), . . . , y′(N_{idft}−1)]. As an example, this mapping may be circularly continuous such that

$${y}^{′} ( {[ m + Q ]}_{{N}_{idft}} ) = y ( m )$$

where Q can take any value from 0 to N_{idft}−1.

At operation 512, the transmitter transforms (e.g., by block 412 of transmitter 400) the output y′=[y′(0), y′(1), . . . , y′(N_{idft}−1)] using IDFT as

$$Y ( n ) = \frac{1}{\sqrt{{N}_{idft}}} {\sum }_{{n}^{′} = 0}^{{N}_{idft - 1}} {y}^{′} ( {n}^{′} ) {e}^{\frac{j 2 π n {n}^{′}}{{N}_{idft}}}$$

to obtain Y=[Y(0), Y(1), . . . , Y(N_{idft}−1)].

At operation 514, the transmitter adds CPs (e.g., by block 414 of transmitter 400) to the IDFT transformed signal Y=[Y(0), Y(1), . . . , Y(N_{idft}−1)] as

$${Y}^{′} ( n ) = Y ( {[ {N}_{idft} - S + n ]}_{{N}_{idft}} )$$

Where S is the length of CP.

Although FIG. 5 illustrates one example procedure 500 for operation of a transmitter, various changes may be made to FIG. 5. For example, while shown as a series of operations, various operations in FIG. 5 could overlap, occur in parallel, occur in a different order, occur any number of times, be omitted, or replaced by other operations.

While various techniques are described above herein to obtain FDSS filters, alternative approaches may be used to obtain FDSS filters.

In some embodiments, for each Rₛₑ(r), T distinct FDSS filters p_{R}_{ₛₑ}_{(r),0}, p_{R}_{ₛₑ}_{(r), 1}, . . . , p_{R}_{ₛₑ}_{(r),T-1} are specified where the FDSS filter p_{R}_{ₛₑ}_{(r),t} is specified using L_{R}_{ₛₑ}_{,t} parameters p_{R}_{ₛₑ}_{(r),t}=[p_{R}_{ₛₑ}_{(r),t} (0), p_{R}_{ₛₑ}_{(r),t} (1), . . . , p_{R}_{ₛₑ}_{(r),t} (L_{R}_{ₛₑ}_{(r),t}−1)].

Based on the p_{R}_{ₛₑ}_{(r),t}, the FDSS coefficient f_{R}_{ₛₑ}_{(r),t}=[f_{R}_{ₛₑ}₍ᵣ₎ₜ (0), f_{R}_{ₛₑ}_{(r),t} (1), . . . , f_{R}_{ₛₑ}_{(r),t} (M_{sc}−1)] is given by

$${f}_{{R}_{s e} ( r ) , t} ( m ) = {p}_{{R}_{s e} ( r ) , t} ( 0 ) + {\sum }_{l = 1}^{{L}_{{R}_{s e} ( r ) , t - 1}} {p}_{{R}_{s e} ( r ) , t} ( l ) ( {e}^{- \frac{j π \tilde{m} l}{{M}_{d}}} + {e}^{- \frac{j π \tilde{m} ( 2 {M}_{d} - 1 )}{{M}_{d}}} )$$

### Where

$$\tilde{m} = {[ - \frac{{M}_{s e}}{2} + m ]}_{2 {M}_{d}}$$

and [·]_{2M}_{_{d}} denotes the modulo operation by 2M_{d}.

Table 3 lists the FDSS filters for a few SE ratios for L_{R}_{ₛₑ}₍ᵣ₎=4. Table 4 lists the FDSS filters for a few SE ratios for L_{R}_{ₛₑ}₍ᵣ₎=2.

TABLE 3
FDSS filters with L_{R}_{ₛₑ}₍ᵣ₎ = 4

| SE ratio (Rₛₑ = | SE ratio (Rₛₑ = | |
|---|---|---|
| Mₛₑ/M_{d}) | Mₛₑ/M_{sc}) | p_{R}_{ₛₑ}₍ᵣ₎_{, t} |
| 1/20 | 1/21 | [1, 0.260, −0.033, 0.012] |
| 1/10 | 1/11 | [1, 0.612, −0.180, 0.060] |
| ⅛ | 1/9 | [1, 0.806, −0.269, 0.086] |
| 3/20 | 3/23 | [1, 0.999, −0.347, 0.113] |
| ⅕ | ⅙ | [1, 1.052, −0.359, 0.110] |
| ¼ | ⅕ | [1, 0.861, −0.265, 0.063] |
| 3/10 | 3/13 | [1, 0.710, −0.182, 0.028] |
| ⅓ | ¼ | [1, 0.634, −0.141, 0.009] |
| ½ | ⅓ | [1, 0.520, −0.059, −0.026] |
| ⅔ | ⅖ | [1, 0.492, −0.032, −0.018] |
| 1 | ½ | [1, 0.467, −0.014, −0.002] |

TABLE 4
FDSS filters with L_{R}_{ₛₑ}₍ᵣ₎ = 2

| SE ratio (Rₛₑ = | SE ratio (Rₛₑ = | |
|---|---|---|
| Mₛₑ/M_{d}) | Mₛₑ/M_{sc}) | p_{R}_{ₛₑ}₍ᵣ₎_{, t} |
| 1/20 | 1/21 | [1, 0.190] |
| 1/10 | 1/11 | [1, 0.222] |
| ⅛ | 1/9 | [1, 0.236] |
| 3/20 | 3/23 | [1, 0.258] |
| ⅕ | ⅙ | [1, 0.295] |
| ¼ | ⅕ | [1, 0.331] |
| 3/10 | 3/13 | [1, 0.365] |
| ⅓ | ¼ | [1, 0.380] |
| ½ | ⅓ | [1, 0.434] |
| ⅔ | ⅖ | [1, 0.459] |
| 1 | ½ | [1, 0.465] |

Alternatively, in some embodiments, for L_{R}_{ₛₑ}₍ᵣ₎=2, the FDSS filters for

$${R}_{s e} ( r ) = \frac{{M}_{s e}}{{M}_{d}} = {z}_{d}$$

are given by

$${p}_{{R}_{s e} ( r )} = [ 1 , 0.131 + 1.031 {z}_{d} - 1.003 {z}_{d}^{2} + 0.306 {z}_{d}^{3} ] \qquad ( 3 )$$

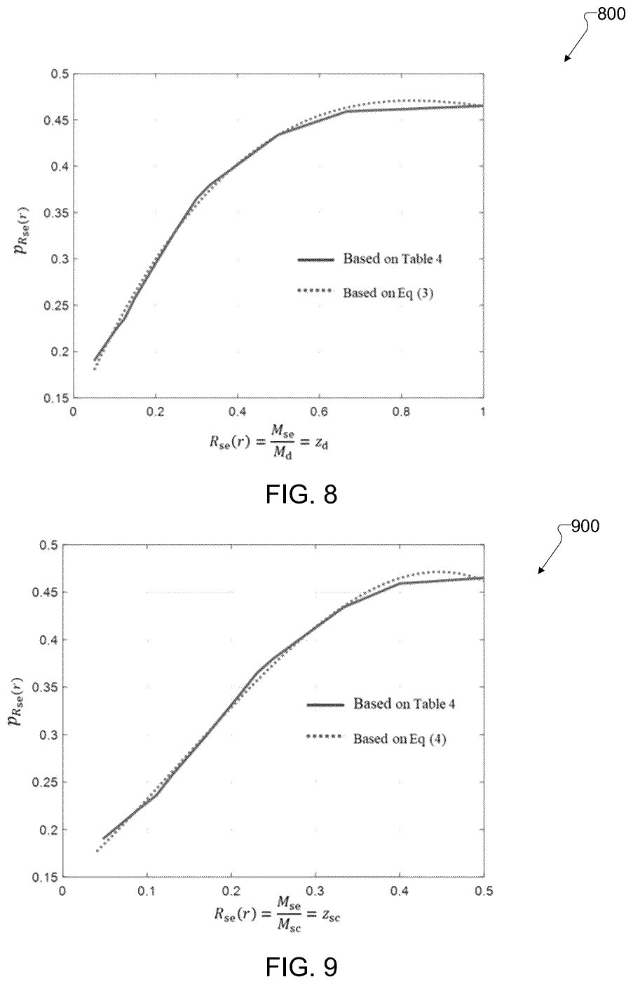

FIG. 8 illustrates another example 800 of values of P_{R}_{ₛₑ}₍ᵣ₎ according to embodiments of the present disclosure. The embodiment of values of P_{R}_{ₛₑ}₍ᵣ₎ of FIG. 8 is for illustration only. Different embodiments of values of P_{R}_{ₛₑ}₍ᵣ₎ could be used without departing from the scope of this disclosure.

In the example of FIG. 8 the values of P_{R}_{ₛₑ}₍ᵣ₎ are based on Table 4 and above equation (3) for

$${R}_{s e} ( r ) = \frac{{M}_{s e}}{{M}_{d}} = {z}_{d} .$$

Alternatively, in some embodiments, for L_{R}_{ₛₑ}₍ᵣ₎=2, the FDSS filters for

$${R}_{s e} ( r ) = \frac{{M}_{s e}}{{M}_{s c}} = {z}_{s c}$$

are given by

$${p}_{{R}_{s e} ( r )} = [ 1 , 0.144 + 0.765 {z}_{s c} + 1.494 {z}_{s c}^{2} - 3.505 {z}_{s c}^{3} ] \qquad ( 4 )$$

FIG. 9 illustrates another example 900 of values of P_{R}_{ₛₑ}₍ᵣ₎ according to embodiments of the present disclosure. The embodiment of values of P_{R}_{ₛₑ}₍ᵣ₎ of FIG. 9 is for illustration only. Different embodiments of values of P_{R}_{ₛₑ}₍ᵣ₎ could be used without departing from the scope of this disclosure.

In the example of FIG. 9, the values of P_{R}_{ₛₑ}₍ᵣ₎ are based on Table 4 and above equation (4) for

$${R}_{s e} ( r ) = \frac{{M}_{s e}}{{M}_{s c}} = {z}_{s c} .$$

In some embodiments, based on the p_{R}_{ₛₑ}_{(r),t}, the FDSS coefficient f_{R}_{ₛₑ}_{(r),t}=[f_{R}_{ₛₑ}_{(r),t} (0), f_{R}_{ₛₑ}_{(r),t} (1), . . . , f_{R}_{ₛₑ}_{(r),t} (M_{sc}−1)] is given by

$${f}_{{R}_{s e} ( r ) , t} ( m ) = {p}_{{R}_{s e} ( r ) , t} ( 0 ) + {\sum }_{l = 1}^{{L}_{{R}_{s e} ( r ) , t} - 1} {p}_{{R}_{s e} ( r ) , t} ( l ) ( {e}^{- \frac{j 2 π \overline{m} l}{{M}_{s c}}} + {e}^{- \frac{j 2 π \overline{m} ( {M}_{s c} - l )}{{M}_{s c}}} )$$

### Where

$$\overline{m} = {[ - \frac{{M}_{s e}}{2} + m ]}_{{M}_{s c}}$$

and [·]_{M}_{_{sc}} denotes the modulo operation by M_{sc}.

Table 5 lists the FDSS filters for a few SE ratios for L_{R}_{ₛₑ}₍ᵣ₎=2.

TABLE 5
FDSS filters with L_{R}_{ₛₑ}₍ᵣ₎ = 2

| SE ratio (Rₛₑ = | SE ratio (Rₛₑ = | |
|---|---|---|
| Mₛₑ/M_{d}) | Mₛₑ/M_{sc}) | p_{R}_{ₛₑ}₍ᵣ₎_{, t} |
| 1/20 | 1/21 | [1, 0.070] |
| 1/10 | 1/11 | [1, 0.086] |
| ⅛ | 1/9 | [1, 0.094] |
| 3/20 | 3/23 | [1, 0.108] |
| ⅕ | ⅙ | [1, 0.132] |
| ¼ | ⅕ | [1, 0.150] |
| 3/10 | 3/13 | [1, 0.169] |
| ⅓ | ¼ | [1, 0.183] |
| ½ | ⅓ | [1, 0.252] |
| ⅔ | ⅖ | [1, 0.328] |
| 1 | ½ | [1, 0.463] |

Alternatively, in some embodiments, for L_{R}_{ₛₑ}₍ᵣ₎=2, the FDSS filters for

$${R}_{s e} ( r ) = \frac{{M}_{s e}}{{M}_{d}} = {z}_{d}$$

are given by

$${p}_{{R}_{s e} ( r )} = [ 1 , 0.045 + 0.418 {z}_{d} ] \qquad ( 5 )$$

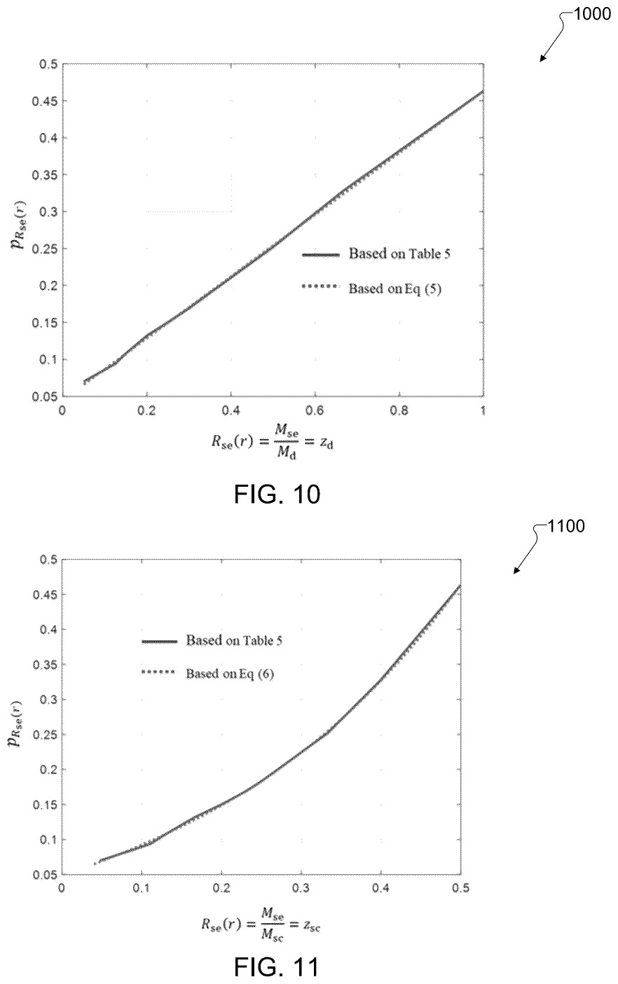

FIG. 10 illustrates another example 1000 of values of P_{R}_{ₛₑ}₍ᵣ₎ according to embodiments of the present disclosure. The embodiment of values of P_{R}_{ₛₑ}₍ᵣ₎ of FIG. 10 is for illustration only. Different embodiments of values of P_{R}_{ₛₑ}₍ᵣ₎ could be used without departing from the scope of this disclosure.

In the example of FIG. 10, the values of P_{R}_{ₛₑ}₍ᵣ₎ are based on Table 5 and above equation (5) for

$${R}_{s e} ( r ) = \frac{{M}_{s e}}{{M}_{d}} = {z}_{d} .$$

Alternatively, in some embodiments, for L_{R}_{ₛₑ}₍ᵣ₎=2, the FDSS filters for

$${R}_{s e} ( r ) = \frac{{M}_{s e}}{{M}_{s c}} = {z}_{s c}$$

are given by

$${p}_{{R}_{s e} ( r )} = [ 1 , 0.048 + 0.413 {z}_{s c} + 0.199 {z}_{s c}^{2} + 1.274 {z}_{s c}^{3} ] \qquad ( 6 )$$

FIG. 11 illustrates another example 1100 of values of P_{R}_{ₛₑ}₍ᵣ₎ according to embodiments of the present disclosure. The embodiment of values of P_{R}_{ₛₑ}₍ᵣ₎ of FIG. 11 is for illustration only. Different embodiments of values of P_{R}_{ₛₑ}₍ᵣ₎ could be used without departing from the scope of this disclosure.

In the example of FIG. 11 the values of P_{R}_{ₛₑ}₍ᵣ₎ based on Table 4 and above equation (6) for

$${R}_{s e} ( r ) = \frac{{M}_{s e}}{{M}_{s c}} = {z}_{s c} .$$

In some embodiments, in order to use the FDSS feature, a new signaling parameter “FDSS” is used to enable and disable the FDSS feature via signaling (such as RRC signaling). An example of RRC pseudo code for the signaling parameter is:
FDSS::=ENUMERATED {enable, disable}

In some embodiments, the communication network may support multiple SEs. In some embodiments, a new field of “SEIndex” with R distinct values 0,1, . . . . R−1 may be used to identify SE ratios Rₛₑ(0), Rₛₑ(1), . . . , Rₛₑ(R−1). These can be represented using log₂R bits according to a specified bit mapping scheme. For example, for R=8 SEIndex can be represented using 3 bits as shown in Table 6. In another example, for R=4 SEIndex can be represented using 2 bits as shown in Table 7.

TABLE 6
Bit mapping for SEIndex for R = 8

| SEIndex | SE Ratio | Bit sequence mapping |
|---|---|---|
| 0 | Rₛₑ(0) | 000 |
| 1 | Rₛₑ(1) | 001 |
| 2 | Rₛₑ(2) | 010 |
| 3 | Rₛₑ(3) | 011 |
| 4 | Rₛₑ(4) | 100 |
| 5 | Rₛₑ(5) | 101 |
| 6 | Rₛₑ(6) | 110 |
| 7 | Rₛₑ(7) | 111 |

TABLE 7
Bit mapping for SEIndex for R = 4

| SEIndex | SE Ratio | Bit sequence mapping |
|---|---|---|
| 0 | Rₛₑ(0) | 00 |
| 1 | Rₛₑ(1) | 01 |
| 2 | Rₛₑ(2) | 10 |
| 3 | Rₛₑ(3) | 11 |

As SEIndex and bitmapping schemes are specified, with the use of signaling (such as RRC signaling) of the log₂R bits, both the transmitter and receiver shall have the knowledge of the chosen SEIndex, and in turn each can find the SE ratio.

If SE is defined as Rₛₑ=Mₛₑ/M_{d}, the example of Table 8 shows four possible versions of SEIndex.

TABLE 8
An example of bit mapping for SEIndex with
Rₛₑ = Mₛₑ/M_{d} for R = 4

| SEIndex | SE Ratio | Bit sequence mapping |
|---|---|---|
| 0 | Rₛₑ(0) = 0.1 | 00 |
| 1 | Rₛₑ(1) = 0.25 | 01 |
| 2 | Rₛₑ(2) = 0.5 | 10 |
| 3 | Rₛₑ(3) = 1 | 11 |

An example of RRC pseudo code for SEIndex is
SEIndex::=INTEGER {0,1, . . . , R−1}

As discussed herein, for each SE ratio Rₛₑ(r), T distinct FDSS filters p_{R}_{ₛₑ}_{(r),0}, p_{R}_{ₛₑ}_{(r),1}, . . . , p_{R}_{ₛₑ}_{(r),T-1} are specified where the FDSS filter p_{R}_{ₛₑ}_{(r),t} is represented by L_{R}_{ₛₑ}₍ᵣ₎, coefficients p_{R}_{ₛₑ}_{(r),t}=[p_{R}_{ₛₑ}_{(r),t}(0), p_{R}_{ₛₑ}_{(r),t} (1), . . . p_{R}_{ₛₑ}_{(r),t}(L_{R}_{ₛₑ}_{(r),t}−1)]. In some embodiments, a new field “FDSSFilterIndex” may be used to distinguish the T distinct FDSS filters p_{R}_{ₛₑ}_{(r),0}, p_{R}_{ₛₑ}_{(r),1}, . . . , p_{R}_{ₛₑ}_{(r),T-1} for Rₛₑ(r) in signaling (such as RRC signaling). The FDSSFilterIndex can be represented using log₂T bits. Examples of T=2 and T=4 are shown in Table 9 and 10.

For example, for T=2 FDSSFilterIndex can be represented using 1 bit as shown in Table 9. In another example, for T=4 FDSSFilterIndex can be represented using 2 bits as shown in Table 10.

TABLE 9
Bit mapping for FDSSFilterIndex for T = 2

| FDSSFilterIndex | FDSS Filter | Bit sequence mapping |
|---|---|---|
| 0 | p_{R}_{ₛₑ}₍ᵣ₎_{, 0} | 0 |
| 1 | p_{R}_{ₛₑ}₍ᵣ₎_{, 1} | 1 |

TABLE 10
Bit mapping for FDSSFilterIndex for T = 4

| FDSSFilterIndex | FDSS Filter | Bit sequence mapping |
|---|---|---|
| 0 | p_{R}_{ₛₑ}₍ᵣ₎_{, 0} | 00 |
| 1 | p_{R}_{ₛₑ}₍ᵣ₎_{, 1} | 01 |
| 2 | p_{R}_{ₛₑ}₍ᵣ₎_{, 2} | 10 |
| 3 | p_{R}_{ₛₑ}₍ᵣ₎_{, 3} | 11 |

An example of RRC pseudo code for SEIndex is
FDSSFilterIndex::=INTEGER {0,1, . . . , T−1}

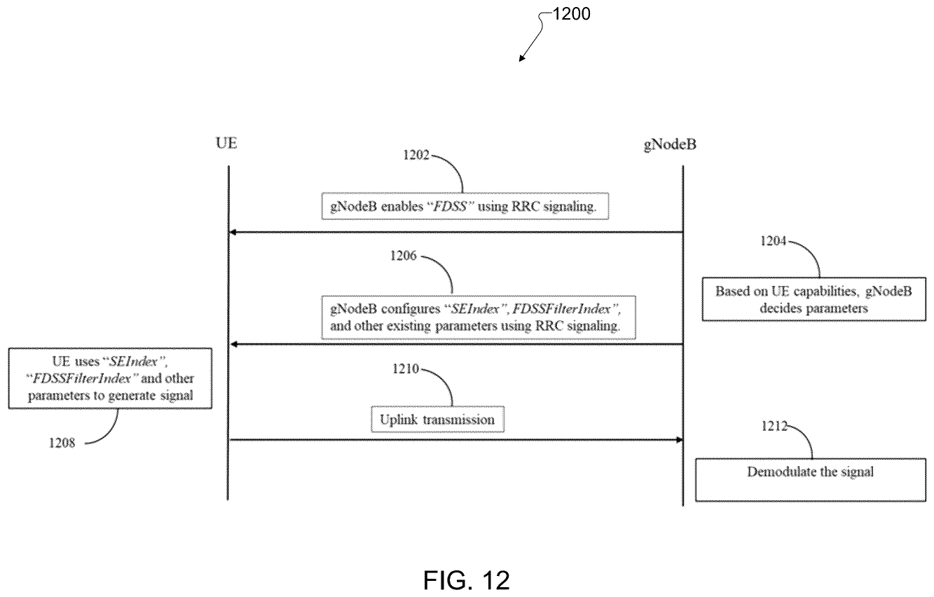

In some embodiments, based on these new additional parameters SEIndex and FDSSFilterIndex, uplink signaling may be performed as shown in FIG. 12.

FIG. 12 illustrates an example procedure 1200 for uplink signaling according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for uplink signaling could be used without departing from the scope of this disclosure.

In the example of FIG. 12, a gNB (such as BS 102 of FIG. 1) is operating as a receiver in the uplink, and a UE (such as UE 116 of FIG. 1) is operating as a transmitter.

Procedure 1200 begins at operation 1202. At operation 1202, the gNB enables FDSS for the UE using signaling. In some embodiments, operation 1202 may be performed using RRC signaling.

In some embodiments, the UE may transmit UE capabilities to the gNB.

At operation 1204, the gNB determines waveform and FDSS parameters for the UE based on the UE's capabilities.

At operation 1206, the gNB configures the parameters SEIndex, FDSSFilterIndex and other parameters for the UE. In some embodiments, the parameters may be configured for the UE using RRC signaling.

At operation 1208, the UE uses configured parameters SEIndex and FDSSFilterIndex to find FDSS coefficients and uses the FDSS coefficients with other parameters to generate a signal for transmission to the gNB.

At operation 1210, the UE transmits the signal to the gNB.

At operation 1212, the gNB demodulates the signal.

In some embodiments, to facilitate the above signaling, the PUSCH-Config of RRC signaling may be amended as follows:

| | |
|---|---|
| PUSCH-Config ::= | SEQUENCE { |
| FDSS ::= | ENUMERATED {enable,disable} |
| SEIndex ::= | INTEGER {0,1,...,R-1} |
| FDSSFilterIndex ::= | INTEGER { 0,1,...,T-1} |

}

Although FIG. 12 illustrates one example procedure 1200 for uplink signaling, various changes may be made to FIG. 12. For example, while shown as a series of operations, various operations in FIG. 12 could overlap, occur in parallel, occur in a different order, occur any number of times, be omitted, or replaced by other operations.

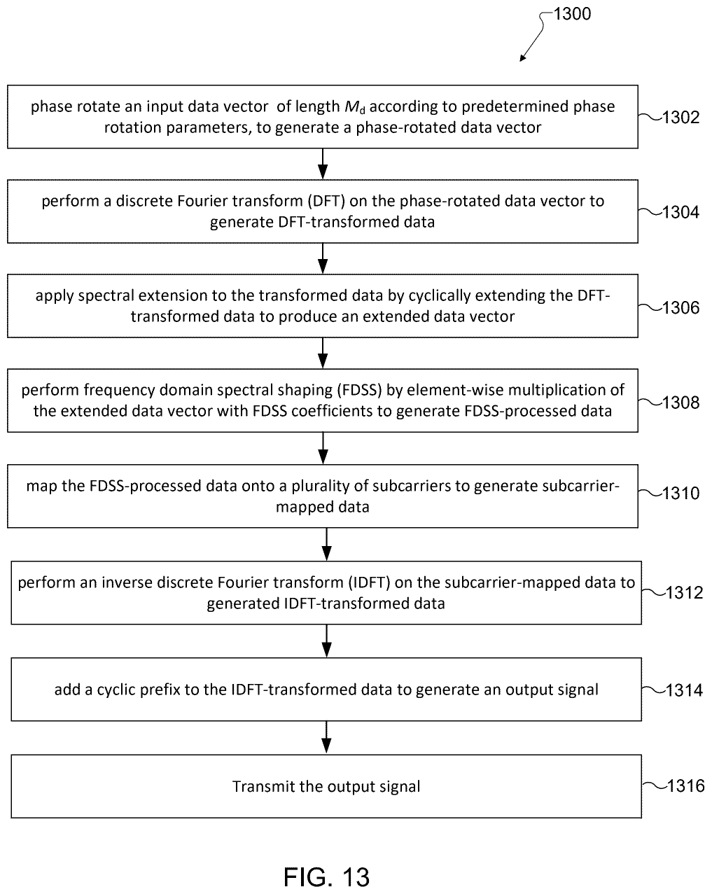

FIG. 13 illustrates an example method 1300 for compact representation of FDSS filters according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for compact representation of FDSS filters could be used without departing from the scope of this disclosure.

In the example of FIG. 13, method 1300 begins at operation 1302. At operation 1302, an electronic device (such as UE 116 or BS 102 of FIG. 1) phase rotates an input data vector u of length Ma according to predetermined phase rotation parameters, to generate a phase-rotated data vector. For example, the phase rotation may be performed similarly as described regarding operation 502 of FIG. 5.

In some embodiments, the data vector u is equal to [u(0), u(1), . . . , u(M_{d}−1)], and the data vector u is phase rotated according to a function

$$v ( m ) = u ( m ) {e}^{- \frac{j 2 π {ϕ}_{m}}{{M}_{d}}} ,$$

generating the phase rotated data vector equal to [v(0), v(1), . . . , v(M_{d}−1)].

At operation 1304, the electronic device performs a DFT on the phase-rotated data vector to generate DFT-transformed data. For example, the DFT may be performed similarly as described regarding operation 504 of FIG. 5.

At operation 1306, the electronic device applies spectral extension to the transformed data by cyclically extending the DFT-transformed data to produce an extended data vector. For example, the spectral extension may be applied similarly as described regarding operation 506 of FIG. 5.

At operation 1308, the electronic device performs FDSS by element-wise multiplication of the extended data vector with FDSS coefficients to generate FDSS-processed data. For example, the FDSS may be performed similarly as described regarding operation 508 of FIG. 5.

In some embodiments, the electronic device determines the FDSS coefficients by applying modulo operations to a cyclically shifted version of the extended data vector, wherein the modulo operation is performed on a plurality of subcarriers (e.g., the subcarriers at operation 1310).

In some embodiments, the electronic device determines the FDSS coefficients based on filters indicated for each of a plurality of spectral extension (SE) ratios. In these embodiments, the filters are represented by a set of coefficients, and the FDSS coefficients are generated using a predetermined number of parameters and a predetermined formula.

In some embodiments, the electronic device is a UE, and the UE receives, from a BS, a signal including a first parameter indicating an SE ratio from the plurality of SE ratios, and a second parameter indicating an FDSS filter corresponding with the SE ratio. In some embodiments, the first parameter and the second parameter are selected by the BS based on at least one capability of the UE.

At operation 1310, the electronic device maps the FDSS-processed data onto a plurality of subcarriers to generate subcarrier-mapped data. For example, the mapping may be performed similarly as described regarding operation 510 of FIG. 5.

At operation 1312, the electronic device performing an IDFT on the subcarrier-mapped data to generate IDFT-transformed data. For example, the IDFT may be performed similarly as described regarding operation 512 of FIG. 5.

At operation 1314, the electronic device adds a cyclic prefix to the IDFT-transformed data to generate an output signal. For example, the cyclic prefix may be added similarly as described regarding operation 514 of FIG. 5.

At operation 1316, the electronic device transmits the output signal.

In some embodiments, the electronic device is a UE, and the UE receives, from a BS signal including a parameter enabling the performance of FDSS at the UE. In these embodiments, phase rotating the data vector u and performing FDSS on the extended data vector are performed based on the signal including the parameter.

Although FIG. 13 illustrates one example procedure 1300 for compact representation of FDSS filters, various changes may be made to FIG. 13. For example, while shown as a series of operations, various operations in FIG. 13 could overlap, occur in parallel, occur in a different order, occur any number of times, be omitted, or replaced by other operations.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a processor configured to:
phase rotate an input data vector u of length Ma according to predetermined phase rotation parameters, to generate a phase-rotated data vector;
perform a discrete Fourier transform (DFT) on the phase-rotated data vector to generate DFT-transformed data;
apply spectral extension to the transformed data by cyclically extending the DFT-transformed data to produce an extended data vector;
perform frequency domain spectral shaping (FDSS) by element-wise multiplication of the extended data vector with FDSS coefficients to generate FDSS-processed data;
map the FDSS-processed data onto a plurality of subcarriers to generate subcarrier-mapped data;
perform an inverse discrete Fourier transform (IDFT) on the subcarrier-mapped data to generate IDFT-transformed data; and
add a cyclic prefix to the IDFT-transformed data to generate an output signal; and
a transceiver operatively coupled to the processor, the transceiver configured to transmit the output signal.

2. The electronic device of claim 1, wherein the processor is further configured to determine the FDSS coefficients by applying modulo operations to a cyclically shifted version of the extended data vector, wherein the modulo operation is performed on the plurality of subcarriers.

3. The electronic device of claim 1, wherein:
the processor is further configured to determine the FDSS coefficients based on filters indicated for each of a plurality of spectral extension (SE) ratios;
the filters are represented by a set of coefficients; and
the FDSS coefficients are generated using a predetermined number of parameters and a predetermined formula.

4. The electronic device of claim 3, wherein:
the electronic device is a UE; and
the transceiver is further configured to receive, from a base station (BS), a signal including a first parameter indicating an SE ratio from the plurality of SE ratios, and a second parameter indicating an FDSS filter corresponding with the SE ratio.

5. The electronic device of claim 4, wherein the first parameter and the second parameter are selected by the BS based on at least one capability of the UE.

6. The electronic device of claim 1, wherein:
the data vector u is equal to [u(0), u(1), . . . , u(M_{d}−1)]; and
the data vector u is phase rotated according to a function
$$v ( m ) = u ( m ) {e}^{- \frac{j 2 π {ϕ}_{m}}{{M}_{d}}} ,$$
generating the phase rotated data vector equal to [v(0), v(1), . . . , v(M_{d}−1)].

7. The electronic device of claim 1, wherein:
the electronic device is a UE;
the transceiver is further configured to receive, from a base station (BS), a signal including a parameter enabling the performance of FDSS at the UE; and
the processor is configured to cause the transceiver to phase rotate the data vector u and perform FDSS on the extended data vector based on the signal including the parameter.

8. A method of operating an electronic device, the method comprising:
phase rotating an input data vector u of length Ma according to predetermined phase rotation parameters, to generate a phase-rotated data vector;
performing a discrete Fourier transform (DFT) on the phase-rotated data vector to generate DFT-transformed data;
applying spectral extension to the transformed data by cyclically extending the DFT-transformed data to produce an extended data vector;
performing frequency domain spectral shaping (FDSS) by element-wise multiplication of the extended data vector with FDSS coefficients to generate FDSS-processed data;
mapping the FDSS-processed data onto a plurality of subcarriers to generate subcarrier-mapped data;
performing an inverse discrete Fourier transform (IDFT) on the subcarrier-mapped data to generate IDFT-transformed data;
adding a cyclic prefix to the IDFT-transformed data to generate an output signal; and
transmitting the output signal.

9. The method of claim 8, further comprising determining the FDSS coefficients by applying modulo operations to a cyclically shifted version of the extended data vector, wherein the modulo operation is performed on the plurality of subcarriers.

10. The method of claim 8, further comprising determining the FDSS coefficients based on filters indicated for each of a plurality of spectral extension (SE) ratios,
wherein the filters are represented by a set of coefficients, and the FDSS coefficients are generated using a predetermined number of parameters and a predetermined formula.

11. The method of claim 10, wherein:
the electronic device is a UE; and
the method further comprises receiving, from a base station (BS), a signal including a first parameter indicating an SE ratio from the plurality of SE ratios, and a second parameter indicating an FDSS filter corresponding with the SE ratio.

12. The method of claim 11, wherein the first parameter and the second parameter are selected by the BS based on at least one capability of the UE.

13. The method of claim 8, wherein:
the data vector u is equal to [u(0), u(1), . . . , u(M_{d}−1)]; and
the data vector u is phase rotated according to a function
$$v ( m ) = u ( m ) {e}^{- \frac{j 2 π {ϕ}_{m}}{{M}_{d}}} ,$$
generating the phase rotated data vector equal to [v(0), v(1), . . . , v(M_{d}−1)].

14. The method of claim 8, wherein:
the electronic device is a UE; and
the method further comprises:
receiving, from a base station (BS), a signal including a parameter enabling the performance of FDSS at the UE; and
phase rotating the data vector u and performing FDSS on the extended data vector based on the signal including the parameter.

15. A non-transitory computer readable medium embodying a computer program comprising program code that, when executed by a processor of a device, causes the device to:
phase rotate an input data vector u of length Ma according to predetermined phase rotation parameters, to generate a phase-rotated data vector;
perform a discrete Fourier transform (DFT) on the phase-rotated data vector to generate DFT-transformed data;
apply spectral extension to the transformed data by cyclically extending the DFT-transformed data to produce an extended data vector;
perform frequency domain spectral shaping (FDSS) by element-wise multiplication of the extended data vector with FDSS coefficients to generate FDSS-processed data;
map the FDSS-processed data onto a plurality of subcarriers to generate subcarrier-mapped data;
perform an inverse discrete Fourier transform (IDFT) on the subcarrier-mapped data to generate IDFT-transformed data;
add a cyclic prefix to the IDFT-transformed data to generate an output signal; and
transmit the output signal.

16. The non-transitory computer readable medium of claim 15, wherein the computer program further comprises program code that, when executed by the processor, causes the device to determine the FDSS coefficients by applying modulo operations to a cyclically shifted version of the extended data vector, wherein the modulo operation is performed on the plurality of subcarriers.

17. The non-transitory computer readable medium of claim 15, wherein the computer program further comprises program code that, when executed by the processor, causes the device to determine the FDSS coefficients based on filters indicated for each of a plurality of spectral extension (SE) ratios,
wherein the filters are represented by a set of coefficients, and the FDSS coefficients are generated using a predetermined number of parameters and a predetermined formula.

18. The non-transitory computer readable medium of claim 17, wherein:
the device is a UE; and
the computer program further comprises program code that, when executed by the processor, causes the device to receive, from a base station (BS), a signal including a first parameter indicating an SE ratio from the plurality of SE ratios, and a second parameter indicating an FDSS filter corresponding with the SE ratio.

19. The non-transitory computer readable medium of claim 18, wherein the first parameter and the second parameter are selected by the BS based on at least one capability of the UE.

20. The non-transitory computer readable medium of claim 15, wherein:
the device is a UE; and
wherein the computer program further comprises program code that, when executed by the processor, causes the device to:
receive, from a base station (BS), a signal including a parameter enabling the performance of FDSS at the UE; and
phase rotate the data vector u and performing FDSS on the extended data vector based on the signal including the parameter.
